(19) United States
(12) Patent Application Publication
(10) Pub. No.: US 2025/0237262 A1
(43) Pub. Date: Jul. 24, 2025

(54) INSULATED BEARING AND METHOD OF MANUFACTURING THE SAME

(71) Applicant: Aktiebolaget SKF, Göteborg (SE)

(72) Inventors: Hongyuan AN, Shanghai (CN); Shuran FAN, Kunming (CN)

(21) Appl. No.: 19/023,836

(22) Filed: Jan. 16, 2025

(30) Foreign Application Priority Data
Jan. 18, 2024 (CN) 202410076835.9
Apr. 23, 2024 (CN) 202410494200.0

(51) Int. Cl. F16C 19/52; F16C 33/62

(52) U.S. Cl. CPC F16C 19/52; F16C 33/62; F16C 2202/30; F16C 2208/04; F16C 2208/36; F16C 2208/40; F16C 2220/04

(57) ABSTRACT

An insulated bearing has an outer ring and/or inner ring as an insulated ring. The insulated ring has a body with a surface having a material removal portion. An insulating layer is overmolded on the body and molded into the material removal portion. A method of manufacturing the insulated bearing includes having a gate used for an injection molding machine for overmolding the insulating layer arranged so the weld seam of the insulating layer after overmolding avoids the main force-loading area of the insulated ring and/or is formed in the insulating layer where the thickness of the insulating layer is at a maximum. The insulated bearing solves the problem of electrical corrosion of bearings used in high-voltage environments. The insulated bearing achieves good electrical insulation and also prevents axial and/or circumferential movement of the insulating layer, improving the electrical performance and life of the insulating layer and the bearing.

### CROSS-REFERENCE TO RELATED APPLICATIONS

This application claims priority to Chinese Application No. 202410494200.0, filed Apr. 23, 2024, and to Chinese Application No. 202410076835.9, filed Jan. 18, 2024, the entireties of each of which are hereby incorporated by reference.

### FIELD

The present disclosure relates to an insulated bearing and a manufacture method thereof.

### BACKGROUND

Bearings are widely used in various types of equipment. Different application fields often impose different requirements on bearings.

Taking electrical equipment such as electric vehicles as an example, since their drive motor shafts, transmission shafts, etc. require the use of bearings, these types of bearings work in a charged environment. Moreover, since the charging of electric vehicles is increasingly pursuing increase of the charging voltage to shorten the charging time, the bearings on the motor shaft are also exposed to higher and higher voltage environments. When current passes through the bearings, electrical corrosion will occur on the bearings.

Therefore, the prior art provides to electrically insulate the bearings to prevent current from flowing through the bearings. Common insulation solutions include electrically insulating at least one of the outer ring, rolling elements, and inner ring of the bearing. For example, one solution is to apply insulating coating on the outer ring, the inner ring or the rolling elements, or even to manufacture the rolling elements directly from insulating material such as ceramic.

A further solution is to mold an insulating layer on the outside of the outer/inner ring of the bearing, which insulating layer is overmolded on the outer circumferential face opposite to the raceway and the axial end face. However, since the bearing tends to move at high speed and under high load, although the insulating layer is overmolded on the outer ring/inner ring, after a long time of operation, the insulating layer inevitably undergoes axial and/or circumferential movement, which in turn causes damage to the insulating layer and affects the insulation of the entire bearing.

Therefore, there is a need in the art for a technical solution that can effectively provide insulation and can effectively prevent movement of the insulation layer.

### SUMMARY

In response to the above-mentioned problems and needs, the present disclosure provides a new technical solution, which solves the above problems and brings other technical effects by adopting the following technical features.

The present disclosure provides an insulated bearing comprising an outer ring, an inner ring, and rolling elements arranged between the outer ring and the inner ring, wherein at least one of the outer ring and the inner ring is provided as an insulated ring having a body which further comprises: a raceway; an axial end face; a radial outer circumferential face, disposed radially away from the raceway; wherein a surface of the body comprises a material removal portion, and an insulating layer is overmolded on the body and molded into the material removal portion.

The present disclosure also provides a method of manufacturing an insulated bearing as described above comprising: a gate used for an injection molding machine for overmolding the insulating layer is arranged so that the weld seam of the insulating layer after overmolding avoids the main force-loading area of the insulated ring and/or is formed in the insulating layer where the thickness of the insulating layer is maximum.

The present disclosure provides an insulated bearing and a manufacture method thereof in order to solve the problem of electrical corrosion of bearings used in high-voltage environments. The present disclosure not only achieves good electrical insulation for the bearing, but also further prevents axial and/or circumferential movement of the insulating layer, greatly improving the electrical performance and life of the insulating layer and the entire bearing.

### BRIEF DESCRIPTION OF DRAWINGS

FIG. 1 is a cross-sectional view of an insulated ring according to a first preferable embodiment of the present disclosure;

FIG. 2 is a partial perspective view of an insulated ring and an enlarged view of a knurling structure according to a first preferable embodiment of the present disclosure;

FIG. 3 is a cross-sectional view of an insulated ring according to a second preferable embodiment of the present disclosure;

FIG. 4 is an enlarged view of a knurling structure in an insulated ring according to a second preferable embodiment of the present disclosure;

FIG. 5 is a cross-sectional view of an insulated ring according to a third preferable embodiment of the present disclosure;

FIG. 6 is an enlarged view of a knurling structure in an insulated ring according to a third preferable embodiment of the present disclosure;

FIG. 7 is a cross-sectional view of an insulated ring according to a fourth preferable embodiment of the present disclosure;

FIGS. 8A and 8B are cross-sectional views of an insulated ring according to a fifth preferable embodiment of the present disclosure;

FIG. 9 is a cross-sectional view of an insulated ring according to a modification of the present disclosure;

FIG. 10 is a schematic view for explaining the formation of weld seam of the insulating layer;

FIG. 11 is a schematic view of the position of each gate in the manufacture method of the insulated bearing according to a preferable embodiment of the present disclosure.

### DETAILED DESCRIPTION

In order to make the purpose, technical solution and advantages of the technical solution of the present disclosure clearer, the technical solution of the embodiment of the present disclosure will be described clearly and completely in the following with the attached drawings of specific embodiments of the present disclosure. Like reference numerals in the drawings represent like components. It should be noted that a described embodiment is a part of the embodiments of the present disclosure, not the whole embodiments. Based on the described embodiments of the present disclosure, all other embodiments obtained by those skilled in the field without creative labor fall into the scope of protection of the present disclosure.

In comparison with the embodiments shown in the attached drawings, feasible embodiments within the protection scope of the present disclosure may have fewer components, other components not shown in the attached drawings, different components, components arranged differently or components connected differently, etc. Furthermore, two or more components in the drawings may be implemented in a single component, or a single component shown in the drawings may be implemented as a plurality of separate components.

Unless otherwise defined, technical terms or scientific terms used herein shall have their ordinary meanings as understood by those skilled in the field to which this disclosure belongs. The terms “first”, “second” and similar terms used in the specification and claims of the patent application of this disclosure do not indicate any order, quantity or importance, but are only used to distinguish different components. When the number of components is not specified, the number of components can be one or more. Similarly, terms such as “a/an”, “the” and “said” do not necessarily mean quantity limitation. Similar terms such as “including” or “comprising” mean that the elements or objects appearing before the terms cover the elements or objects listed after the terms and their equivalents, without excluding other elements or objects. Similar terms such as “installation”, “setting”, “connection” or “coupling” are not limited to physical or mechanical installation, setting and connection, but can include electrical installation, setting and connection, whether directly or indirectly. “Up”, “down”, “left” and “right” are only used to indicate the relative orientation relationship when the equipment is used or the orientation relationship shown in the attached drawings. When the absolute position of the described object changes, the relative orientation relationship may also change accordingly.

For the convenience of explanation, the direction of the rotation axis of the bearing is called an axial direction, and the direction perpendicular to the axial direction is called a radial direction. The term “inner/inward” refers to the direction toward the inside of the bearing, whereas the term “outer/outward” refers to the direction toward the outside of the bearing. Besides, same reference numbers refer to components with same or similar structure or function.

An insulated bearing according to the disclosure will be described below with reference to a preferable embodiment shown in the accompanying drawings. The insulated bearing according to the present disclosure comprising an outer ring, an inner ring (not shown), and rolling elements (not shown) provided between the outer ring and the inner ring, and the like.

Usually, the outer ring and the inner ring are also collectively called rings. As mentioned before, in order to achieve the insulation for the bearing, at least one of the outer ring and the inner ring can be provided as an insulated ring. Therefore, the insulated ring of the insulated bearing according to the present disclosure comprises a body further including: a raceway; an axial end face; a radial outer circumferential face disposed radially away from the raceway; wherein, a surface of the body (1) comprises a groove and an insulating layer is overmolded and embedded in the groove, so that the groove effectively retains the insulating layer to prevent the insulating layer from moving axially/circumferentially. It should be understood that said surface may be any suitable surface or surfaces on the body of the insulated ring (this surface, of course, does not include the raceway surface), and the groove may be a groove(s) in any form and any number formed on the surface.

The insulated bearing according to the disclosure will be further described below with reference to preferable embodiments of the disclosure.

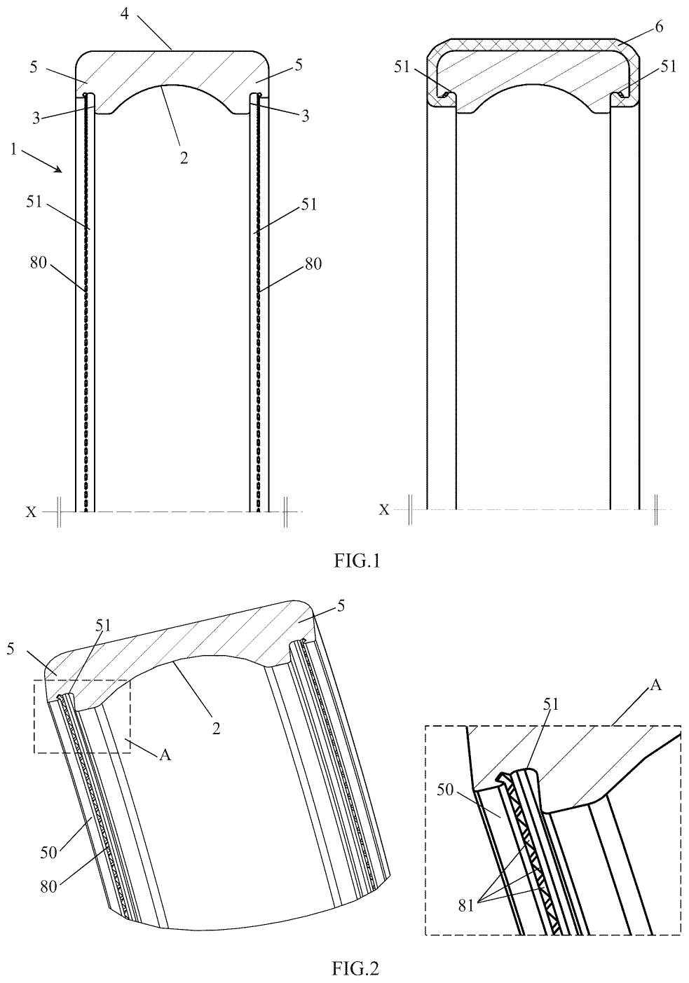

FIGS. 1 and 2 show a first preferable embodiment according to the present disclosure. This embodiment and the other embodiments described below all take the outer ring of the bearing as an example to introduce the features of the insulated bearing and its insulated ring according to the present disclosure.

Specifically, the body 1 of the insulated ring of the first preferable embodiment comprises: a raceway 2; an axial end face 3; a radial outer circumferential face 4 disposed radially away from the raceway 2; an axial flange 5 projecting axially outward with respect to the axial end face 3 and having a radial inner circumferential face 50 (see FIG. 2) facing the inside of the bearing, said radial inner circumferential face 50 comprising an inner radial groove 51 (which is generally recessed in the radial direction); wherein, the insulating layer 6 is overmolded on the radial outer circumferential face 4 and the axial flange 5, and the insulating layer 6 is embedded in said inner radial groove 51.

The left view of FIG. 1 shows a state when the insulating layer 6 is not overmolded, and the right view of FIG. 1 shows a state after the insulating layer 6 is overmolded.

It should be appreciated that the inner radial groove 51 may be formed by any suitable means, such as by machining like turning. The insulating layer 6 may be formed by any suitable overmolding means. According to the present disclosure, by providing such an inner radial groove 51, the molded insulating layer 6 is embedded in said inner radial groove, and thus movement of the insulating layer 6 in the axial direction X can be effectively prevented.

Referring further to FIG. 2, a partial perspective view of the insulated ring and an enlarged view of part A are shown. Further preferably, the inner radial groove 51 also includes a knurling structure 80. The knurling structure 80 is machined by a hob cutter to form an uneven structure on the surface of the inner radial groove 51, that is, tens or even hundreds of small notches 81 are further machined in the inner radial groove 51. The knurling structure 80 may be, for example, a straight knurling. In addition, as shown in FIG. 2, the knurling structure 80 is formed on the side of the inner radial groove 51 farther from the raceway 2. However, according to actual needs, in a not-shown preferable embodiment, such knurling structure may be formed on the other side of the inner radial groove 51 closer to the raceway 2 and/or on bottom of the inner radial groove 51.

By machining the knurling structure 80 in the inner radial groove 51, the insulating layer 6 will be further embedded in the notches 81 of the knurling structure 80, thereby strengthening the connection between the insulating layer 6 and the inner radial groove 51. Moreover, since the knurling structures 80 are distributed along the circumferential direction of the body 1 of the ring, circumferential movement of the insulating layer 6 can be prevented.

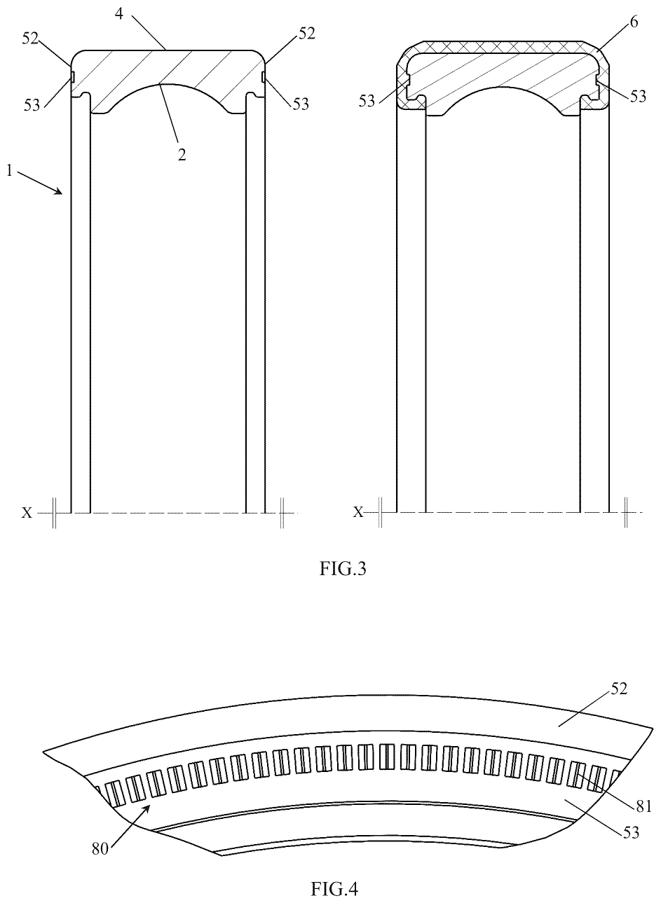

FIG. 3 shows a second preferable embodiment of the present disclosure. In this preferable embodiment, the axial flange 5 of the body 1 of the insulated ring may comprise an axial groove(s) 53 (which is substantially recessed in the axial direction) on its axial outer end face 52, and said insulating layer 6 is further embedded in said axial groove 53, as shown by the right view of FIG. 3.

Further preferably, as shown in FIG. 4, the axial groove 53 may also comprise a knurling structure 80, and the insulating layer 6 is further embedded in the notches 81 of the knurling structure 80 to further strengthen the connection between the insulating layer 60 and the axial groove 53, thereby preventing circumferential movement of the insulating layer 6. The knurling structure 80 is formed, for example, on the bottom of the axial groove 53. According to a not-shown embodiment, the knurling structure may be formed in side surfaces of the axial groove 53.

FIG. 5 shows a third preferable embodiment of the present disclosure, which is a further improvement to the first and/or second preferable embodiment. In this third preferable embodiment, the body 1 of the insulated ring further comprises a corner groove 7 provided at an intersection part between the radial outer circumferential face 4 and the axial flange 5. There are preferably two corner grooves 7, and the insulating layer 6 is further embedded in the corner grooves 7, as shown by the right view of FIG. 5. By providing such corner grooves 7, movement of the insulating layer 6 in the axial direction can be effectively prevented.

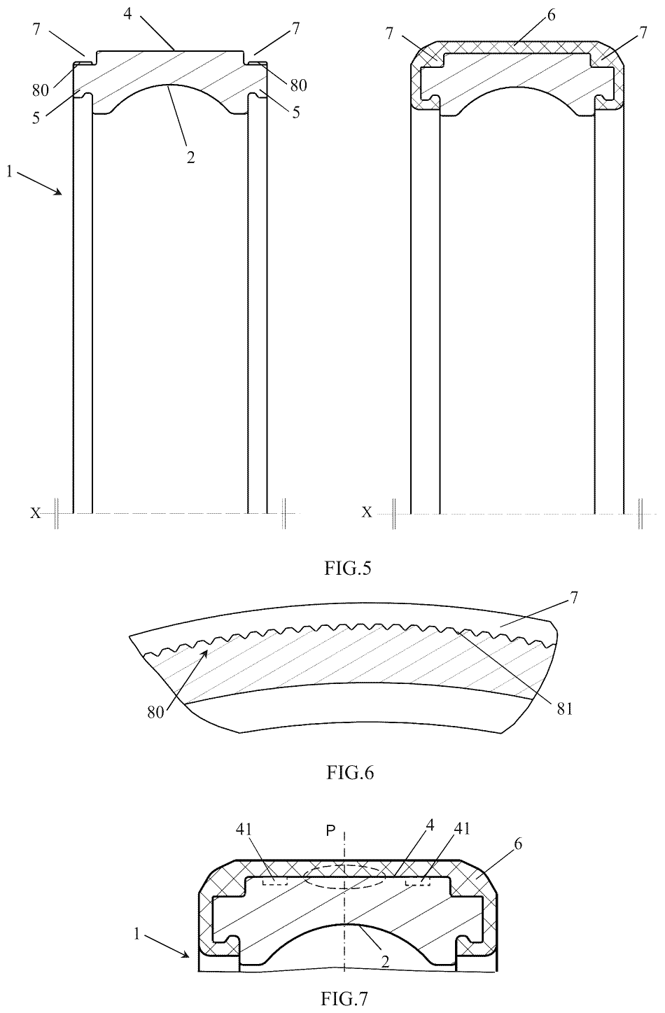

Further preferably, referring to FIG. 6, the corner groove 7 may also comprise a knurling structure 80, and the insulating layer 6 is further embedded in the notches 81 of the knurling structure 80 to further strengthen the connection between the insulating layer 60 and the corner groove 7. As shown in FIG. 6, the knurling structure 80 is provided on the bottom of the corner groove 7. According to a not-shown embodiment, the knurling structures 80 may also be provided on the side surface of the corner groove 7.

FIG. 7 shows a fourth preferable embodiment of the present disclosure. Although FIG. 7 is shown with reference to the cross-sectional view of the third embodiment of FIG. 5, it should be understood that this can be a modification of any of the previously described preferable embodiments, or can be implemented separately.

Specifically, in this fourth preferable embodiment, the radial outer circumferential face 4 of the body 1 of the insulated ring may comprise an outer radial groove 41 (shown in dashed lines, substantially radially recessed). There are preferably two outer radial grooves, and the insulating layer 6 is further embedded in the outer radial grooves 41.

Further preferably, the outer radial groove 41 may also include a knurling structure (not shown), for example, disposed on the bottom and/or side surfaces of the outer radial groove 41, and the insulating layer 6 is further embedded in the notches of the knurling structure.

It should be understood that when such outer radial grooves 41 are formed only on the radial outer circumferential face 4 and the outer radial grooves 41 exist independently of the other grooves mentioned above, the effect of preventing axial/circumferential movement of the insulated ring can be also achieved. Therefore, the axial flange 5 and its related grooves in the aforementioned preferable embodiment can be cancelled. Therefore, the positions of the outer radial grooves 41 can be flexibly adjusted, for example, it may be disposed at the intersection part between the radial outer circumferential face 4 and the axial end face 3, like the corner groove 7 in the third preferable embodiment of FIG. 5.

In addition, since the insulated ring usually bears a certain radial force, and the radial force mainly acts on a main force-loading area in the middle of the insulated ring (as shown by the dotted ellipse in FIG. 7), therefore, if an outer radial groove 41 is arranged in the middle of the insulated ring, a larger stress concentration will be generated. Therefore, it is further preferable that the outer radial groove 41 is arranged offset along the axial direction relative to the raceway symmetry plane P (the raceway symmetry plane P is perpendicular to the axial direction X and the raceway 2 is generally symmetrical with respect to the raceway symmetry plane P), so that the outer radial groove 41 is away from the main force-loading area of the insulated ring, thereby preventing the outer radial groove 41 from adversely affecting the force-loading condition of the bearing.

In addition, since the grooves in the embodiment of FIG. 6 are arranged at the corners, so that there are no grooves on its radial outer circumferential face 4, its force-loading condition is relatively better than that in the embodiment of FIG. 7, and is more suitable for bearings that need to withstand large radial forces.

According to a further preferable modification of the present disclosure, any one of the inner radial groove 51, the axial groove 53, the corner groove 7 and the outer radial groove 41 as described above may be provided as one continuous groove or a plurality of discontinuous grooves in the circumferential direction. When a plurality of discontinuous grooves are formed (not shown), said plurality of grooves can be evenly or unevenly spaced in the circumferential direction and their number may be set and adjusted according to actual needs, and thus circumferential movement of the insulating layer can be can effectively prevented.

According to a further preferable modification of the present disclosure, in addition to providing knurling structures in various types of grooves as described above, a knurling structure (not shown), such as reticulated knurling, may be provided on at least one of the radial outer circumferential face 4 and the axial outer end face 52 of the axial flange 5, and the insulating layer 6 is further embedded in the notches of the knurling structure.

Preferably, the material of the insulating layer 6 may comprise one of: polyetheretherketone (PEEK), polyphenylene sulfide (PPS), polyimide (PI). This type of material not only has good insulation property, but also balances strength and wear resistance, and is more suitable for use in the insulated bearing according to the present disclosure. Further preferably, for situations where the bearing needs to withstand a large force, reinforcing fibers can be added to the material of the insulating layer 6 to further enhance the stiffness of the insulating layer 6. The reinforcing fiber is, for example, glass fibers etc. For example, PEEK-GF30 (30% glass fiber added to PEEK) can be used as the material of the insulating layer 6. In addition, thickness of the insulating layer 6 may be appropriately set according to the structure of the bearing, insulation performance requirements, etc. For example, for bearings commonly used in electric drive assemblies of electric vehicles, in order to avoid electrical corrosion, thickness of the insulating layer 6 needs to be set to be equal to or greater than 0.45 mm, preferably between 0.6 mm and 1 mm, and more preferably 0.8 mm.

On the other hand, in the aforementioned preferable embodiments, the molded insulating layer 6 forms the outermost layer of the insulated ring. Considering the application environment of the bearing, especially when the outer ring is manufactured as an insulated ring, since the outer ring usually contacts other components (such as the housing), sometimes there may be matching and/or kinematic relationship with other components. Therefore, the insulating layer 6 formed by injection molding is not good enough to form accurate match with other components due to its poor dimensional accuracy. Moreover, during shipping of the bearing, the insulating layer 6 is also prone to undergo collision and wear, and in worst cases, insulation performance thereof is compromised.

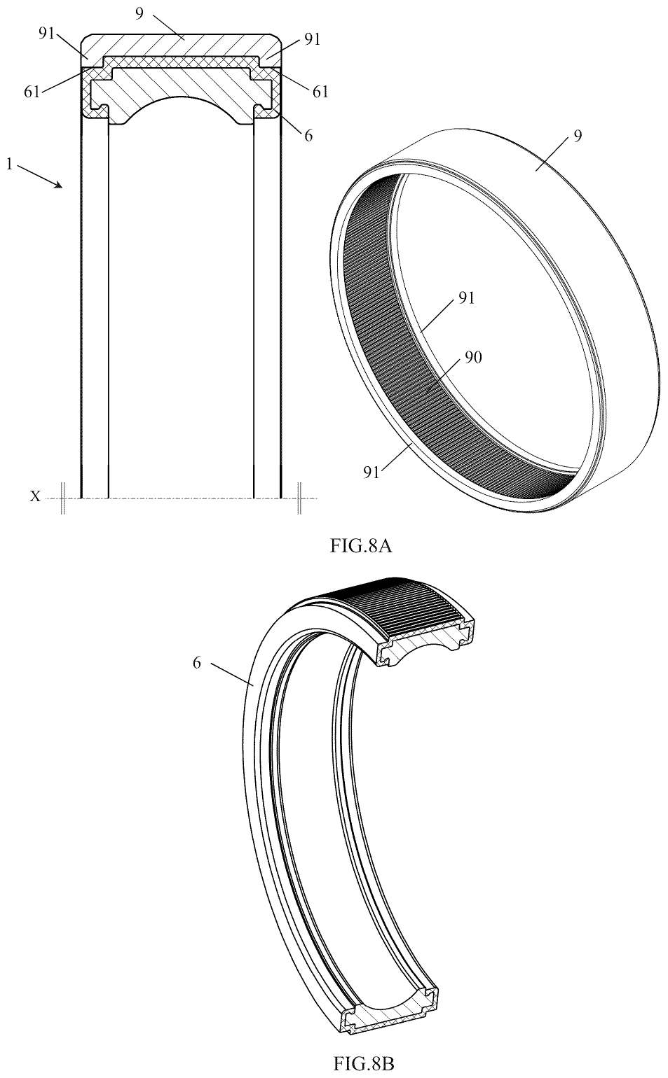

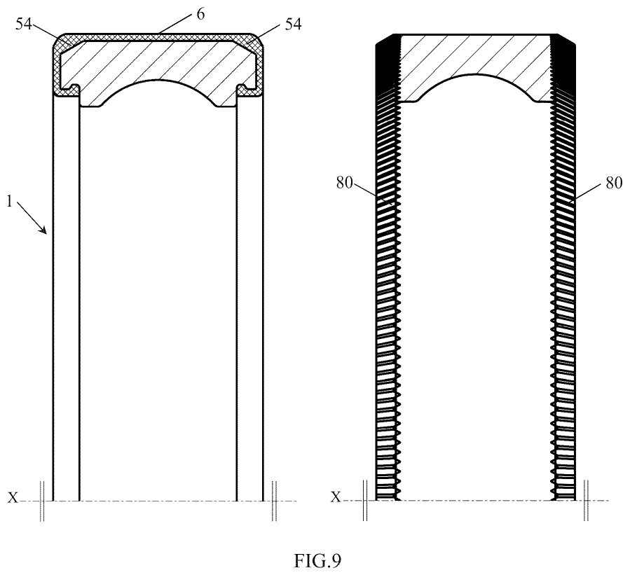

Therefore, according to a fifth preferable embodiment of the present disclosure as shown in FIGS. 8A and 8B, the present disclosure further provides that an outer metal ring 9 is provided outside the insulating layer 6. The outer metal ring 9 at least covers the radial outer face of the insulating layer 6. Preferably, the axial width of the outer metal ring 9 may be slightly larger than the axial width of the insulating layer 6.

During the manufacturing process of this insulated ring, for example, the outer metal ring 9 and the body 1 of the ring may be firstly placed in an injection mold, and then material of insulating layer 6 in liquid state is injected into the mold from an appropriate position. The outer metal ring 9 can be connected to and cover the radial outer face of the insulating layer 6 after the insulating layer 6 is molded, thereby forming an insulated ring with the outer metal ring 9. Of course, the outer metal ring 9 may be connected to and cover the radial outer face of the insulating layer 6 by any other suitable means.

Since the outer metal ring 9 is a relatively rigid component, it is easier to control the dimensional accuracy, so that the entire ring and even the entire bearing will easily meet the matching requirements with other components, and the outer metal ring 9 also provides good wear resistance and collision resistance.

Preferably, the inner surface (such as the radial inner circumferential face) of the outer metal ring 9 may also comprise a knurling structure 90, and the insulating layer 6 is further embedded in the groove of the knurling structure 90 of the outer metal ring 9 (not marked). FIG. 8B further shows the removal of the outer metal ring 9 after the insulating layer 6 is molded, to show the status of the portion of the insulating layer 6 embedded in the knurling structure 90. This embedded connection between the knurling structure 90 and the insulating layer 6 can effectively prevent radial movement between the outer metal ring 9 and the insulating layer 6.

Preferably, the outer metal ring 9 includes a flange 91 extending radially from its outer periphery, which flange is embedded in a corner groove 61 of the insulating layer 6. With this arrangement, axial movement between the outer metal ring 9 and the insulating layer 6 can be further prevented.

Although FIGS. 8A and 8B show the addition of the outer metal ring 9 to the third preferable embodiment shown in FIG. 5, it should be understood that, according to other preferable embodiments not shown, the outer metal ring 9 can be applied to other preferable embodiments shown in FIGS. 1, 3 and 7, and will not be described and shown again.

According to the above-described preferable embodiment of the disclosure, restriction to the axial and/or circumferential movement of the insulating layer is achieved by providing “grooves” on the body of the ring, and the specific form and number of the grooves are not limited in any way. In other words, those skilled in the art will understand that the principle of the present disclosure is to increase the resistance to the axial and/or circumferential direction movement of the insulating layer by removing some material from the body of the ring and allowing the molded insulating layer to enter these material removal portions.

Therefore, according to another modification of the present disclosure, as shown in FIG. 9, a beveled portion(s) 54 is provided at an intersection part between the radial outer circumferential face 4 and the axial flange 5, and the insulating layer 6 can be molded into the beveled portion 54. Thereby, since this beveled portion 54 is inclined with respect to the axial direction and the radial direction, it may also provide resistance to the movement of the insulating layer 6 in the axial direction, and such resistance is same as that of the “grooves” (such as the corner groove 7) of the preferable embodiment described previously (although the beveled portion 54 differs from the specific form of the groove described previously, both of them are material removal portions). Preferably, a knurling structure 80 as previously described is also provided on the surface of this beveled portion 54 to further provide restriction to the movement of the insulating layer 6 in the circumferential direction.

In addition, the modification shown in FIG. 9 may be combined with any of the foregoing preferable embodiments as needed. For example, the beveled portion 54 may be provided in the preferable embodiment shown in FIGS. 1-2, that is, the ring can comprise both the groove 51 and the beveled portion 54 to provide a better effect of preventing axial and circumferential movement of the insulating layer 6. Further preferably, the beveled portion(s) 54 may be provided as one continuous beveled portion or a plurality of discontinuous beveled portions in the circumferential direction

Furthermore, the outer metal ring 9 shown in FIGS. 8A and 8B may be applied to the insulating layer 6 in the modification of FIG. 9, and will not be described again here.

Finally, it should be understood that, depending on different bearing structures, there are cases where the axial end face 3 coincides with the axial outer end face 52 of the axial flange 5; in other words, the ring may not comprise the axially protruding axial flange 5, but both sides of the body 1 may only comprise axial end faces 3. In this case, grooves 51 in the first preferable embodiment may not exist, so that even if only the material removal portion (such as the grooves 53, 7, 41 or the beveled portions 54) in the embodiment of FIGS. 3, 5, 7, 9 is provided, the effect of preventing axial/circumferential movement of the insulating layer 6 can be achieved too. For example, in a not-shown embodiment in which the axial flange 5 does not exist, grooves like the grooves 53 may be provided on the axial end faces 3; corner grooves such as the corner grooves 7 may be provided at the intersection parts between the axial end faces 3 and the radial outer circumferential face 4; beveled portions such as the beveled portions 54 may be provided at the intersection parts between the axial end face 3 and the radial outer circumferential face 4.

In summary, the present disclosure provides providing material removal portions (e.g., various grooves or beveled portions) on the surfaces of the body of the insulated ring (i.e., on any suitable surfaces) as long as they provide resistance to the axial/circumferential movement of the insulating layer. Further, according to the principle of the present disclosure, the above-mentioned knurling structure may be understood as a form of material removal portion too.

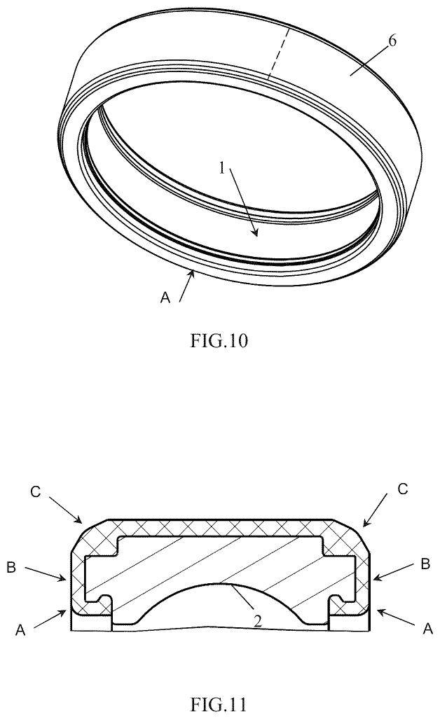

As mentioned before, in the insulated bearing of the present disclosure the insulating layer is applied on the insulated ring by overmolding, which is usually done by an injection molding machine. Referring to FIG. 10, generally speaking, if a gate used for an injection molding machine is set to inject insulating layer material centrally in the axial direction from position A, liquid insulating layer material will flow in the mold along each possible flow direction of the ring 1. Viewing from the circumferential direction, liquid insulating layer material will meet and form a weld seam at the dotted line position on the opposite side of the gate position A (i.e., a position approximately 180° symmetrical with respect to position A), that is, the weld seam will be formed in the main force-loading area of the ring. However, in general, strength of the weld seam is poor, so that formation of the weld seam in this main force-loading area adversely affects the loading and operation of the bearing, and may cause premature failure of the insulating layer itself.

Therefore, according to another aspect of the present disclosure, the present disclosure also provides a method of manufacturing an insulated bearing. This method is mainly optimized for the gate position used for the injection molding machine for overmolding the insulating layer, so that the weld seam of the overmolded insulating layer 6 avoids the main force-loading area of the insulated ring and/or formed at a position where thickness of the insulating layer 6 is maximum.

For example, referring to FIG. 11 (with reference to a cross-sectional view of the third preferable embodiment) and FIGS. 1, 3, 5, 7 and 9, according to the method of the present disclosure, the gate used for the injection molding machine may be placed at a plurality of positions: for example, a gate may be placed substantially facing the inner circumferential face 50 of the axial flange 5, as indicated by arrow A, which is more suitable for the first preferable embodiment of FIG. 1; a gate may be placed facing the axial outer end face 52 of the axial flange 5, as shown by arrow B, which is more suitable for the second preferable embodiment of FIG. 3 and the fifth preferable embodiment of FIGS. 8A and 8B; a gate may be placed facing the intersection part between the radial circumferential face 4 and the axial flange 5, as shown by arrow C, which is more suitable for the third preferable embodiment of FIG. 5, the third preferable embodiment of FIG. 7 and the four preferable embodiments and modifications of FIG. 9.

Of course, it should be understood that although preferable gate positions are set forth above for various preferable embodiments, this is not a limitation. Depending on actual needs, the gate positions described above may be used in other preferable embodiments. According to actual needs, it is also possible to select a plurality of positions from the above-mentioned positions to provide a plurality of gates for a certain preferable embodiment.

Finally, although not shown, those skilled in the art will understand that the inner and outer rings of the bearing are arranged on both sides of the rolling elements, and the inner ring has a substantially symmetrical structure with the outer ring. For example, the inner ring also includes a raceway, an axial end face, a radial outer circumferential face (which is opposite to the inner ring raceway and usually faces the rotating shaft), etc. Therefore, the inner ring may also similarly include various types of grooves described in the above preferable embodiment for retaining the insulating layer, and/or an outer metal ring connected to and covering the insulating layer of the inner ring (which may be in contact with the rotating shaft), which will not be described in detail here. That is to say, the “insulated ring” of the present disclosure can be the outer ring of the bearing or the inner ring of the bearing, as long as it implements the principle of the present disclosure.

In summary, the present disclosure provides an insulated bearing and a manufacture method thereof in order to solve the problem of electrical corrosion of bearings used in high-voltage environments. The present disclosure not only achieves good electrical insulation for the bearing, but also further prevents axial and/or circumferential movement of the insulating layer, greatly improving the electrical performance and life of the insulating layer as well as the entire bearing.

The exemplary embodiments of the present disclosure have been described in detail above with reference to preferable embodiments. However, those skilled in the art will understand that various modifications and modifications can be made to the above specific embodiments without departing from the concept of the present disclosure. Modifications, and various technical features and structures proposed in the present disclosure can be made in various combinations without exceeding the scope of protection of the present disclosure, which is determined by the appended claims.

What is claimed is:

1. An insulated bearing comprising:
an outer ring;
an inner ring; and
rolling elements arranged between the outer ring and the inner ring;
at least one of the outer ring or the inner ring is provided as an insulated ring having a body, the body comprising:
a raceway;
an axial end face;
a radial outer circumferential face disposed radially away from the raceway; and
a surface having a material removal portion;
the insulated ring having an insulating layer overmolded on the body and molded into the material removal portion.

2. The insulated bearing according to claim 1, wherein the surface of the body comprises a groove as said material removal portion, and the insulating layer is overmolded on the body and embedded in the groove.

3. The insulated bearing according to claim 2, wherein the body comprises:
an axial flange projecting axially outward with respect to the axial end face and having a radial inner circumferential face facing the inside of the bearing, the radial inner circumferential face comprising an inner radial groove as said groove;
wherein an insulation layer is overmolded on the radial outer circumferential face and the axial flange, and the insulation layer is embedded in the inner radial groove.

4. The insulated bearing according to claim 2, wherein:
the body comprises an axial flange projecting axially outward with respect to the axial end face and further comprising an axial groove as said groove provided on an axial outer end face thereof, and the insulation layer is embedded in said axial groove; or
the body includes an axial groove as said groove provided on the axial end face, and the insulating layer is embedded in the axial groove.

5. The insulated bearing according to claim 1, wherein:
the body further comprises a corner groove as said groove provided at an intersection part between the radial outer circumferential face and the axial flange, and the insulating layer is embedded in the corner groove; or
the body further comprises a corner groove as said groove provided at the intersection part between the radial outer circumferential face and the axial end face, and the insulating layer is embedded in the corner groove.

6. The insulated bearing according to claim 2, wherein the radial outer circumferential face further comprises an outer radial groove as said groove, and the insulating layer is embedded in said outer radial groove; preferably, the outer radial groove is arranged offset along the axial direction relative to the raceway symmetry plane.

7. The insulated bearing according to claim 1, wherein
the body comprises an axial flange projecting axially outward with respect to said axial end face and having a beveled portion as said material removal portion at the intersection part between said radial outer circumferential face and said axial flange; or
the body further comprises a beveled portion as the material removal portion provided at the intersection part between the radial outer circumferential face and the axial end face.

8. The insulated bearing according to claim 3, wherein at least one of the inner radial groove, the axial groove, the corner groove, the outer radial groove and the beveled portion comprises a knurling structure, and the insulating layer is embedded in the notches of the knurling structure.

9. The insulated bearing according to claim 3, wherein at least one of the inner radial groove, the axial groove, the corner groove and the outer radial groove is provided as one continuous groove or a plurality of discontinuous grooves in a circumferential direction;
the beveled portion is provided as one continuous beveled portion or a plurality of discontinuous beveled portions in the circumferential direction.

10. The insulated bearing according to claim 1, wherein at least one of the radial outer circumferential face, an axial outer end face of the axial flange and the axial end face comprises a knurling structure, and the insulating layer is further embedded in the notches of the knurling structure.

11. The insulated bearing according to claim 1, wherein the material of the insulating layer comprises one of: polyetheretherketone, polyphenylene sulfide, or polyimide.

12. The insulated bearing according to claim 11, wherein the insulating layer includes reinforcing fibers added to the material of the insulating layer to enhance the strength of the insulating layer.

13. The insulated bearing according to claim 1, wherein the insulated bearing further comprising an outer metal ring connected to and covering at least a radial outer face of said insulating layer.

14. The insulated bearing according to claim 13, wherein the inner surface of the outer metal ring comprises a knurling structure, and the insulating layer is further embedded in the notches of the knurling structure of the outer metal ring.

15. The insulated bearing according to claim 13, wherein preferably the outer metal ring comprises a flange extending radially from its outer circumference, and the flange is embedded in a corner groove of the insulating layer.

16. The insulated bearing according to claim 1, wherein a thickness of the insulating layer is set equal to or greater than 0.45 mm.

17. A method of manufacturing an insulated ring for an insulated bearing, the method comprising:
overmolding an insulating layer onto a body, said overmolding including arranging a gate of an injection molding machine so that the weld seam of the insulating layer after overmolding avoids the main force-loading area of the insulated ring and/or is formed in the insulating layer where the thickness of the insulating layer is at a maximum.

18. The method of claim 17, wherein said arranging comprises arranging the gate of the injection molding machine so that the weld seam of the insulating layer after overmolding avoids the main force-loading area of the insulated ring.

19. The method of claim 17, wherein said arranging comprises arranging the gate of the injection molding machine so that the weld seam of the insulating layer after overmolding is formed in the insulating layer where the thickness of the insulating layer is at a maximum.
